(19) United States
(12) Patent Application Publication
(10) Pub. No.: US 2025/0215250 A1
(43) Pub. Date: Jul. 3, 2025

(54) FORMALDEHYDE-FREE AQUEOUS PIGMENT COMPOSITION AND COATED ARTICLES PREPARED WITH THE SAME

(71) Applicants: Dow Global Technologies LLC, Midland, MI (US); Rohm and Haas Company, Collegeville, PA (US)

(72) Inventors: Yin Xue, Shanghai (CN); Xinhong Wang, Shanghai (CN); Sergio Ariel Solari, Tarragon (ES); Isabelle Uhl, Saint-Denis (FR); Shailendra Nagotkar, Navi Mumbai (IN)

(21) Appl. No.: 18/851,862

(22) PCT Filed: Apr. 29, 2022
(86) PCT No.: PCT/CN2022/090289

§ 371 Date: Sep. 27, 2024

(51) Int. Cl. C09D 11/107; C09D 11/037

(52) U.S. Cl. CPC C09D 11/107; C09D 11/037

(57) ABSTRACT

Disclosed is a formaldehyde-free aqueous pigment composition comprising (A) an aqueous emulsion comprising a hydroxyl group functionalized copolymer, (B) an aqueous dispersion comprising a carboxylic acid group functionalized (co) polymer, (C) pigment and (D) thickener. The aqueous pigment composition can be used for forming delicate printing pattern on the surface of various substrates and has superior performance properties such as washing resistance, bond strength, weathering resistance, yellowing resistance, cracking resistance, delamination resistance, and the like. A coated article having a coating layer formed with the aqueous pigment composition is also disclosed.

### FIELD OF THE INVENTION

The present disclosure relates to a unique formaldehyde-free pigment composition which is printable and aqueous, and a coated article, such as garment, having colored pattern formed by using the pigment composition. The formulation of the pigment composition is particularly designed to achieve superior performance properties such as washing resistance, color fastness, bond strength, weathering resistance, yellowing resistance, cracking resistance, delamination resistance, and the like.

### BACKGROUND

Pigment compositions are useful for a wide variety of applications. For instance, they can be used to apply symbols, patterns or characters onto the surface of various articles such as garment, tent, packaging material, container, vessel, building, vehicle, furniture, industrial apparatus, household appliances etc. Pigment compositions having good dispersion stability and uniform fineness can be applied to the substrate with a printer to form delicate and vivid image, pattern or symbols. Nevertheless, the coated (e.g. by printing) articles prepared by using the pigment composition face two challenges: the first one is how to develop an environmental friendly formulation which is free of toxic ingredients such as toluene, xylene, benzene, toluene diisocyanate (TDI), heavy metals, VOC (volatile organic compounds), and most importantly, formaldehyde; the second challenge is the difficulty in maintaining good mechanical properties, such as washing resistance, color fastness, bond strength, weathering resistance, yellowing resistance, cracking resistance, delamination resistance, and the like. Some formaldehyde-free formulations are known in the prior art, but none of them have actually overcome both of the challenges. Therefore, there is a long-standing need to develop a unique pigment composition which can be used for the production of a coated article exhibiting the above stated performance properties even after long duration exposure to harsh outdoor climate.

After persistent exploration, we have surprisingly developed a unique formaldehyde-free pigment composition which can achieve the above stated targets.

### SUMMARY OF THE INVENTION

The present disclosure provides a unique formaldehyde-free pigment composition, and a coated article prepared by using the same.

In a first aspect of the present disclosure, the present disclosure provides a formaldehyde-free aqueous pigment composition, comprising: (A) an aqueous emulsion comprising a hydroxyl group functionalized copolymer derived from the polymerization of monomers including, based on the total weight of the copolymer, from 0.2 wt % to 15 wt % of at least one hydroxyl-containing ethylenically unsaturated C₂-C₁₂ carboxylic monomer, from 70 wt % to 95 wt % of at least one ethylenically unsaturated C₂-C₁₂ mono-carboxylic monomer, from 0.2 wt % to 15 wt % of at least of ethylenically unsaturated C₂-C₁₂ di-carboxylic monomer; (B) an aqueous dispersion comprising a carboxylic acid group functionalized (co)polymer derived from the polymerization of monomer(s) comprising at least one ethylenically unsaturated C₂-C₁₂ carboxylic monomer; (C) pigment; and (D) thickener. According to an embodiment of the first aspect, the aqueous pigment composition is free of ingredients which contain formaldehyde or can release formaldehyde, such as N-methylolacrylamide (NMA) and N-methylolmethacrylamide (NMMA). According to another embodiment of the first aspect, the aqueous pigment composition is a printable aqueous composition.

In a Second aspect of the present disclosure, the present disclosure provides a coated article comprising a substrate and a coating layer at least partially covering one or both sides of the substrate, wherein the coating layer is formed with the formaldehyde-free pigment composition of the present disclosure. According to an embodiment of the second aspect, the substrate can be selected from the group consisting of woven fabric, nonwoven fabric, paper, cardboard, wood, wool, cotton, silk, leather, rubber, plastic membrane/film, metal membrane/sheet, glass fiber fabric, carbon fiber fabric, cement, concrete and combinations thereof.

It is to be understood that both the foregoing general description and the following detailed description are exemplary and explanatory only and are not restrictive of the invention, as claimed.

### BRIEF DESCRIPTION OF THE DRAWINGS

FIG. 1 is a schematic view of a coated article according to an embodiment of the present disclosure; and

FIG. 2 is a cross-section of the coated article as shown in FIG. 1.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, “and/or” means “and, or as an alternative”. All ranges include endpoints unless otherwise indicated. The term “carboxylic monomer” comprises a monomer having carboxylic acid group(s) or any derivatives thereof, such as carboxylate anionic group, ester of carboxylic acid [e.g. (C₁-C₁₆)alkyl ester of carboxylic acid], and amide of carboxylic acid. The term “(meth)acrylic” refers to acrylic or methacrylic, and the term (meth)acrylamide refers to acrylamide or methacrylamide.

Without being limited to any specific theory, the technical breakthrough of the present disclosure mainly resides in the particularly designed formulation of the pigment composition. Especially, it is found that the curable system prepared by using (A) an aqueous emulsion comprising a hydroxyl group functionalized copolymer derived from the polymerization of monomers including, based on the total weight of the copolymer, from 0.2 wt % to 15 wt % of at least one hydroxyl-containing ethylenically unsaturated C₂-C₁₂ carboxylic monomer, from 70 wt % to 95 wt % of at least one ethylenically unsaturated C₂-C₁₂ mono-carboxylic monomer, from 0.2 wt % to 15 wt % of at least of ethylenically unsaturated C₂-C₁₂ di-carboxylic monomer, (B) an aqueous dispersion comprising a carboxylic acid group functionalized (co)polymer derived from the polymerization of monomer(s) comprising at least one ethylenically unsaturated C₂-C₁₂ carboxylic monomer, (C) pigment and (D) thickener can be used to apply image, pattern, symbol, character, letter, number, etc. on various substrates and exhibit desirable performance properties. It is also found that the categories and relative contents of the ingredients used for each of the above stated components can be further modified to achieve further improvements in the performance properties of the pigment composition and the coated article.

### The Aqueous Emulsion (A)

According to an embodiment of the present disclosure, the aqueous emulsion (A) comprises a hydroxyl group functionalized copolymer derived from the polymerization of monomers including, based on the total weight of the copolymer, from 0.2 wt % to 15 wt % of at least one hydroxyl-containing ethylenically unsaturated C₂-C₁₂ carboxylic monomer, from 70 wt % to 95 wt % of at least one ethylenically unsaturated C₂-C₁₂ mono-carboxylic monomer, and from 0.2 wt % to 15 wt % of at least of ethylenically unsaturated C₂-C₁₂ di-carboxylic monomer.

The hydroxyl-containing ethylenically unsaturated C₂-C₁₂ carboxylic monomer refers to a C₂-C₁₂ carboxylic monomer comprising at least one ethylenically unsaturated group (e.g. vinyl, allyl, etc.) and at least one hydroxyl group, and examples thereof include hydroxyl(C₁-C₁₂)alkyl (meth)acrylate, hydroxyl(C₁-C₁₂)alkyl crotonate, hydroxyl(C₁-C₁₂)alkyl pentenate, hydroxyl(C₁-C₁₂)alkyl 3,3-dimethyl pentenate, hydroxyl(C₁-C₁₂)alkyl hexenoate, hydroxyl(C₁-C₁₂)alkyl heptenoate, hydroxyl(C₁-C₁₂)alkyl octenoate, hydroxyl(C₁-C₁₂)alkyl nonenoate, hydroxyl(C₁-C₁₂)alkyl decenoate, hydroxyl(C₁-C₁₂)alkyl fumarate, di(hydroxyl(C₁-C₁₂)alkyl) fumarate, (hydroxyl(C₁-C₁₂)alkyl) ((C₁-C₁₂)alkyl) fumarate, hydroxyl(C₁-C₁₂)alkyl maleate, di(hydroxyl(C₁-C₁₂)alkyl) maleate, (hydroxyl(C₁-C₁₂)alkyl)((C₁-C₁₂)alkyl) maleate, hydroxyl(C₁-C₁₂)alkyl 2-methylmaleate, di(hydroxyl(C₁-C₁₂)alkyl)2-methylmaleate, (hydroxyl(C₁-C₁₂)alkyl)((C₁-C₁₂)alkyl) 2-methylmaleate, hydroxyl(C₁-C₁₂)alkyl itaconate, di(hydroxyl(C₁-C₁₂)alkyl) itaconate, (hydroxyl(C₁-C₁₂)alkyl)((C₁-C₁₂)alkyl) itaconate, hydroxyl(C₁-C₁₂)alkyl 2-methyl-itaconate, di(hydroxyl(C₁-C₁₂)alkyl) 2-methyl-itaconate, (hydroxyl(C₁-C₁₂)alkyl)((C₁-C₁₂)alkyl) 2-methyl-itaconate, hydroxyl(C₁-C₁₂)alkyl glutaconate, di(hydroxyl(C₁-C₁₂)alkyl) glutaconate, (hydroxyl(C₁-C₁₂)alkyl)((C₁-C₁₂)alkyl) glutaconate, hydroxyl(C₁-C₁₂)alkyl muconate, di(hydroxyl(C₁-C₁₂)alkyl) muconate, (hydroxyl(C₁-C₁₂)alkyl)((C₁-C₁₂)alkyl) muconate, or combinations thereof. As used herein, the term “hydroxyl(C₁-C₁₂)alkyl” refers to a (C₁-C₁₂)alkyl with one hydrogen atom attached to any carbon atom has been substituted with a hydroxyl group. Particularly, the hydroxyl-containing ethylenically unsaturated C₂-C₁₂ carboxylic monomer can be selected from the group consisting of hydroxymethyl methacrylate, hydroxymethyl acrylate, hydroxyethyl methacrylate, hydroxyethyl acrylate, hydroxypropyl methacrylate, hydroxypropyl acrylate, hydroxybutyl methacrylate, hydroxybutyl acrylate, hydroxyethyl crotonate, and combinations thereof.

According to an embodiment of the present disclosure, the content of the hydroxyl-containing ethylenically unsaturated C₂-C₁₂ carboxylic monomer can be from 0.2 wt % to 15 wt %, based on the total weight of the hydroxyl group functionalized copolymer, such as 0.5-12 wt %, or 0.8-10 wt %, or 1-8 wt %, or 1.2-6 wt %, or 1.4-5 wt %, or 1.5-3 wt %, or 1.6-2.8 wt %, or 2-2.2 wt %, or within a numerical range obtained by combining any two of the following end point values: 0.2 wt %, 0.3 wt %, 0.4 wt %, 0.5 wt %, 0.6 wt %, 0.7 wt %, 0.8 wt %, 0.9 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, 2 wt %, 2.2 wt %, 2.5 wt %, 2.8 wt %, 3 wt %, 3.5 wt %, 3.8 wt %, 4 wt %, 4.5 wt %, 5 wt %, 5.5 wt %, 6 wt %, 6.5 wt %, 7 wt %, 7.5 wt %, 8 wt %, 8.5 wt %, 9 wt %, 9.5 wt %, 10 wt %, 10.5 wt %, 11 wt %, 11.5 wt %, 12 wt %, 12.5 wt %, 13 wt %, 13.5 wt %, 14 wt %, 14.5 wt %, 15 wt %.

The ethylenically unsaturated C₂-C₁₂ mono-carboxylic monomer refers to a C₂-C₁₂ carboxylic monomer comprising one ethylenically unsaturated group (e.g. vinyl, allyl, etc.) and one carboxylic group, and having no hydroxyl group, and examples thereof can be selected from the group consisting of (meth)acrylic acid, crotonic acid, pentenoic acid, hexenoic acid, heptenic acid, octenoic acid, nonenoic acid, caproleic acid, and salt, anhydride or (C₁-C₁₂)alkyl ester thereof. Particularly, the ethylenically unsaturated C₂-C₁₂ mono-carboxylic monomer can be selected from the group consisting of acrylic acid, methacrylic acid, crotonic acid, methyl methacrylate, methyl acrylate, ethyl methacrylate, ethyl acrylate, propyl methacrylate, propyl acrylate, butyl methacrylate, butyl acrylate, methyl crotonate, ethyl crotonate, propyl crotonate, butyl crotonate, and combinations thereof. According to a specific embodiment of the present disclosure, the ethylenically unsaturated C₂-C₁₂ mono-carboxylic monomer comprises a mixture of (meth)acrylic acid and (C₁-C₄)alkyl (meth)acrylate, such as a mixture of acrylic acid and butyl acrylate.

According to an embodiment of the present disclosure, the content of the ethylenically unsaturated C₂-C₁₂ mono-carboxylic monomer can be from 70 wt % to 95 wt %, based on the total weight of the hydroxyl group functionalized copolymer, such as 74-92 wt %, or 78-90 wt %, or 80-89 wt %, or 84-88 wt %, or 85-88 wt %, or 86-87.5 wt %, or 87-87.5 wt %, or within a numerical range obtained by combining any two of the following end point values: 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %. According to another embodiment of the present disclosure, the ethylenically unsaturated C₂-C₁₂ mono-carboxylic monomer may comprise a mixture of (meth)acrylic acid and (C₁-C₄)alkyl (meth)acrylate, wherein the content of the (meth)acrylic acid can be from 1 to 20 wt %, based on the total weight of the hydroxyl group functionalized copolymer, such as 1.2-16 wt %, or 1.5-12 wt %, or 2-10 wt %, or 2.2-8 wt %, or 2.4-5 wt %, or 2.7-3 wt %, or within a numerical range obtained by combining any two of the following end point values: 1 wt %, 1.2 wt %, 1.4 wt %, 1.5 wt %, 1.8 wt %, 2 wt %, 2.2 wt %, 2.4 wt %, 2.5 wt %, 2.7 wt %, 2.8 wt %, 3 wt %, 3.5 wt %, 4 wt %, 4.5 wt %, 5 wt %, 5.5 wt %, 6 wt %, 6.5 wt %, 7 wt %, 7.5 wt %, 8 wt %, 8.5 wt %, 9 wt %, 9.5 wt %, 10 wt %, 10.5 wt %, 11 wt %, 11.5 wt %, 12 wt %, 12.5 wt %, 13 wt %, 13.5 wt %, 14 wt %, 14.5 wt %, 15 wt %, 15.5 wt %, 16 wt %, 16.5 wt %, 17 wt %, 17.5 wt %, 18 wt %, 18.5 wt %, 19 wt %, 19.5 wt %, 20 wt %; and the content of the (C₁-C₄)alkyl (meth)acrylate can be from 60 to 90 wt %, based on the total weight of the hydroxyl group functionalized copolymer, such as 65-90 wt %, or 70-89 wt %, or 72-88 wt %, or 75-87 wt %, or 78-86 wt %, or 80-85 wt %, or 82-84.5 wt %, or within a numerical range obtained by combining any two of the following end point values: 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %. According to an embodiment of the present disclosure, the ethylenically unsaturated C₂-C₁₂ mono-carboxylic monomer comprises a mixture of 0.5-5 wt %, e.g. 1-3 wt % acrylic acid and 75-86 wt %, e.g. 82-86 wt % butyl acrylate, based on the total weight of the hydroxyl group functionalized copolymer.

The ethylenically unsaturated C₂-C₁₂ di-carboxylic monomer refers to a C₂-C₁₂ carboxylic monomer comprising at least one ethylenically unsaturated group and two carboxylic groups, and having no hydroxyl group, and examples thereof can be selected from the group consisting of fumaric acid, maleic acid, 2-methyl maleic acid, itaconic acid, 2-methyl itaconic acid, glutaconic acid, muconic acid, and salt, anhydride or ester thereof. Particularly, the ethylenically unsaturated C₂-C₁₂ di-carboxylic monomer can be selected from the group consisting of fumaric acid, maleic acid, itaconic acid, (C₁-C₆)alkyl fumarate, di((C₁-C₆)alkyl) fumarate, (C₁-C₆)alkyl maleate, di((C₁-C₆)alkyl) maleate, (C₁-C₆)alkyl itaconate, di((C₁-C₆)alkyl itaconate) and combinations thereof.

According to an embodiment of the present disclosure, the content of the ethylenically unsaturated C₂-C₁₂ di-carboxylic monomer can be from 0.2 wt % to 15 wt %, based on the total weight of the hydroxyl group functionalized copolymer, such as 0.3-12 wt %, or 0.4-10 wt %, or 0.5-8 wt %, or 0.8-7 wt %, or 1-6 wt %, or 1.2-5 wt %, or 1.3-4 wt %, or 1.4-3 wt %, or 1.5-2.5 wt %, or 1.6-2 wt %, or within a numerical range obtained by combining any two of the following end point values: 0.2 wt %, 0.3 wt %, 0.4 wt %, 0.5 wt %, 0.6 wt %, 0.7 wt %, 0.8 wt %, 0.9 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, 2 wt %, 2.2 wt %, 2.5 wt %, 3 wt %, 3.5 wt %, 4 wt %, 4.5 wt %, 5 wt %, 6 wt %, 7 wt %, 8 wt %, 9 wt %, 10 wt %, 11 wt %, 12 wt %, 13 wt %, 14 wt %, 15 wt %. According to a specific embodiment, the ethylenically unsaturated C₂-C₁₂ di-carboxylic monomer comprises 0.5-2 wt % itaconic acid.

According to an embodiment of the present disclosure, the monomers for preparing the hydroxyl group functionalized copolymer further comprise at least one additional comomoner selected from the group consisting of styrenic monomer, (meth)acrylamide, butadiene, isoprene, vinyl acetate, (meth)acrylonitrile, and combinations thereof; wherein the styrenic monomer includes styrene and any derivatives thereof such as α-methylstyrene (AMS), benzyl acrylate, 2-phenoxyethyl acrylate, butyl styrene, methylstyrene, methoxystyrene, hydroxylstyrene, or any combinations thereof. The content of the additional comomoner can be from 0 to 20 wt %, based on the total weight of the hydroxyl group functionalized copolymer, such as 0 wt %, or 0.5-18 wt %, or 1-17 wt %, or 2-16 wt %, or 4-15 wt %, or 5-12 wt %, or 6-10 wt %, or 8-9 wt %; or within a numerical range obtained by combining any two of the following end point values: 0 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %. According to a specific embodiment, the additional comonomer comprises 7-10 wt % of styrene.

According to another embodiment of the present disclosure, the aqueous emulsion (A) can be a two-stage emulsion of (i) a first stage component comprising the above stated hydroxyl group functionalized copolymer; and (ii) a second stage component comprising a (co)polymer derived from the polymerization of monomer(s) including one or more ethylenically unsaturated monomers. The ratio between the solid weight of the first stage component and the solid weight of the second stage component can be from 20:1 to 1:1, such as from 15:1 to 2:1, or 12:1 to 5:1, or 10:1 to 6:1, or 9:1 to 8:1.

According to another embodiment of the present disclosure, the ethylenically unsaturated monomer for the second stage component can be selected from the group consisting of (meth)acrylic acid, crotonic acid, pentenoic acid, hexenoic acid, heptenic acid, octenoic acid, nonenoic acid, caproleic acid, fumaric acid, maleic acid, 2-methyl maleic acid, itaconic acid, and salt, anhydride, (C₁-C₁₂)alkyl ester or hydroxyl(C₁-C₁₂)alkyl ester thereof; hydroxyl-functionalized ethylenically unsaturated C₂-C₁₆ carboxylic acid; styrenic monomer; (meth) acrylamide; diene; vinyl (C₁-C₁₀)carboxylate; (meth)acrylonitrile; and combinations thereof; wherein the styrenic monomer includes styrene and any derivatives thereof such as α-methylstyrene (AMS), benzyl acrylate, 2-phenoxyethyl acrylate, butyl styrene, methylstyrene, methoxystyrene, hydroxylstyrene, or any combinations thereof. Particularly, the ethylenically unsaturated monomer for the second stage component can be selected from methacrylic acid, acrylic acid, crotonic acid, fumaric acid, maleic acid, itaconic acid, (C₁-C₆)alkyl thereof, hydroxyl(C₁-C₆)alkyl thereof; styrene, (meth)acrylamide, butadiene, isoprene, vinyl acetate, (meth)acrylonitrile, and combinations thereof. According to a specific embodiment, the ethylenically unsaturated monomer for the second stage component can be a mixture of styrene and acrylic acid, such as a mixture of 50-90 wt % styrene and 10-50 wt % of acrylic acid.

As used herein, the term “aqueous emulsion” refers to the dispersion of a water-insoluble polymer which may be prepared by conventional polymerization techniques such as, by emulsion polymerization. The aqueous emulsion (A) of the present disclosure can be prepared by the emulsion polymerization of the above stated monomers/comonomer(s) in a proper solvent, such as water, and one or more additives or processing aids, such as surfactant, initiator, catalyst, crosslinking agent, chain transfer agent, buffering agent, pH regulator, or combinations thereof, may be optionally employed as desired in the emulsion polymerization reaction. According to an embodiment in which the aqueous emulsion is a two-stage emulsion, the two-stage emulsion can be prepared by successively adding the raw materials for each stage into the emulsion polymerization vessel. For example, the two-stage emulsion can be prepared by firstly adding the monomers/comonomers for the first-stage, and when the first stage polymerization has finished or has basically finished, adding the monomers/comonomers for the second stage. Without being limited to any specific theory, the two-stage emulsion polymerization may produce an aqueous emulsion comprising polymer particles with certain morphologies such as mixed-phase structure (in which the first stage polymer is blended with the second stage polymer) or core-shell structure (in which the first stage polymer core is partially or completely capsulated with the second stage polymer shell). Without being limited to any specific theory, an aqueous pigment composition prepared with such a two-stage aqueous emulsion may exhibit an additional enhancement in the performance properties, such as color fastness, washing resistance, etc. over the aqueous pigment composition prepared with an one-stage aqueous emulsion.

The emulsion polymerization can be conducted at a temperature of from ambient temperature to 120° C., such as from 40° C. to 100° C., or from 50° C. to 90° C., or from 60° C. to 84° C. in air or under the protection of an inert atmosphere (e.g. nitrogen or argon gas).

Conventional surfactant includes anionic emulsifier, nonionic emulsifier or combination thereof. Typical anionic emulsifier includes, but is not limited to alkali or ammonium alkyl sulfate, alkali or ammonium alkylether sulfate, alkali or ammonium alkylarylether sulfate, alkali or ammonium alkyl sulfonate, salts of fatty acids, ester of sulfosuccinic acid salt, alkyl diphenylether disulfonate, and salts or free acids of complex organic phosphate esters. Typical nonionic emulsifier includes, but is not limited to polyether, e.g. poly(ethylene oxide) or poly(propylene oxide). According to a specific embodiment of the present disclosure, the surfactant comprises dodecyl benzene sulfonate salt, such as sodium dodecyl benzene sulfonate. The content of the surfactant can be from 0.1 wt % to 5 wt %, based on the total weight of the aqueous emulsion, such as 0.5-4.5 wt %, or 1-4 wt %, or 1.5-3 wt %, or 2-2.5 wt %, or within a numerical range obtained by combining any two of the following end point values: 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.2 wt %, 1.3 wt %, 1.5 wt %, 1.6 wt %, 1.7 wt %, 1.8 wt %, 1.9 wt %, 2 wt %, 2.2 wt %, 2.3 wt %, 2.5 wt %, 2.6 wt %, 2.8 wt %, 3 wt %, 3.1 wt %, 3.2 wt %, 3.5 wt %, 3.6 wt %, 3.8 wt %, 4 wt %, 4.1 wt %, 4.2 wt %, 4.5 wt %, 4.8 wt %, 5 wt %.

The initiator may comprise azo initiator, peroxide initiator and oxidization-reduction initiator, and particular examples of the initiator include azodiisobutyronitrile (ABIN), azobisisoheptonitrile (ABVN), ammonia persulfate (APS), sodium persulfate (SPS), dibenzoyl peroxide (BPO), diisopropyl peroxydicarbonate (IPP), dilauroyl peroxide (LPO), tert-butyl hydroperoxide (t-BHP), as well the oxidation-reduction initiator system formed by combining any one of the above indicated peroxide with a reducing agent, e.g. isoascorbic acid (IAA), Fe(SO₄)₂, etc. According to a specific embodiment of the present disclosure, the initiator comprises APS, t-BHP/IAA or t-BHP/IAA/Fe(SO₄)₂. The content of the initiator can be from 0.1 wt % to 9 wt %, based on the total weight of the aqueous emulsion, such as 0.5-8 wt %, or 1-6 wt %, or 2-5 wt %, or 3-4 wt %, or within a numerical range obtained by combining any two of the following end point values: 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.2 wt %, 1.3 wt %, 1.5 wt %, 1.6 wt %, 1.7 wt %, 1.8 wt %, 1.9 wt %, 2 wt %, 2.2 wt %, 2.3 wt %, 2.5 wt %, 2.6 wt %, 2.8 wt %, 3 wt %, 3.1 wt %, 3.2 wt %, 3.5 wt %, 3.6 wt %, 3.8 wt %, 4 wt %, 4.1 wt %, 4.2 wt %, 4.5 wt %, 4.8 wt %, 5 wt %, 5.5 wt %, 6 wt %, 6.5 wt %, 6.8 wt %, 7 wt %, 7.2 wt %, 7.5 wt %, 7.8 wt %, 8 wt %, 8.2 wt %, 8.5 wt %, 9 wt %.

According to an embodiment of the present disclosure, the aqueous emulsion (A) has a water content of 40 wt % to 95 wt %, based on the total weight of the aqueous emulsion (A), such as 45-90 wt %, or 48-80 wt %, or 50-70 wt %, or 55-60 wt %, or within a numerical range obtained by combining any two of the following end point values: 40 wt %, 42 wt %, 45 wt %, 48 wt %, 50 wt %, 52 wt %, 55 wt %, 58 wt %, 60 wt %, 62 wt %, 65 wt %, 68 wt %, 70 wt %, 72 wt %, 75 wt %, 78 wt %, 80 wt %, 82 wt %, 85 wt %, 88 wt %, 90 wt %, 91 wt %, 92 wt %, 93 wt %, 94 wt %, 95 wt %. Tap water, distilled water, redistilled water or ionized water can be selected according to the specific applications or industrial standards for the pigment composition of the present disclosure.

The relative content of the aqueous emulsion (A) can be from 2 wt % to 18 wt %, or 4-16 wt %, or 6-14 wt %, or 8-12 wt %, or 9-10 wt %, based on the total weight of the aqueous pigment composition, or within a numerical range obtained by combining any two of the following end point values: 2 wt %, 2.5 wt %, 3 wt %, 3.5 wt %, 4 wt %, 4.5 wt %, 5 wt %, 5.5 wt %, 6 wt %, 6.5 wt %, 7 wt %, 7.5 wt %, 8 wt %, 8.5 wt %, 8.8 wt %, 8.9 wt %, 9 wt %, 9.2 wt %, 9.5 wt %, 10 wt %, 10.5 wt %, 11 wt %, 11.5 wt %, 12 wt %, 12.5 wt %, 13 wt %, 13.5 wt %, 14 wt %, 15 wt %, 16 wt %, 17 wt %, 18 wt %.

### The Aqueous Dispersion (B)

According to an embodiment of the present disclosure, the ethylenically unsaturated C₂-C₁₂ carboxylic monomer for the aqueous dispersion (B) can be selected from the group consisting of (meth)acrylic acid, crotonic acid, pentenoic acid, hexenoic acid, heptenic acid, octenoic acid, nonenoic acid, caproleic acid, fumaric acid, maleic acid, 2-methyl maleic acid, itaconic acid, 2-methyl itaconic acid, glutaconic acid, muconic acid, and salt, anhydride or (C₁-C₁₂)alkyl ester thereof. Particularly, the ethylenically unsaturated C₂-C₁₂ carboxylic monomer for the aqueous dispersion (B) can be selected from the group consisting of methacrylic acid, acrylic acid, crotonic acid, fumaric acid, maleic acid, itaconic acid, (C₁-C₆)alkyl methacrylate, (C₁-C₆)alkyl acrylate, (C₁-C₆)alkyl crotonate, (C₁-C₆)alkyl fumarate, di((C₁-C₆)alkyl) fumarate, (C₁-C₆)alkyl maleate, di((C₁-C₆)alkyl) maleate, (C₁-C₆)alkyl itaconate, di((C₁-C₆)alkyl) itaconate, and combinations thereof. According to an exemplary embodiment, the aqueous dispersion (B) may comprise an acrylic (co)polymer, such as a copolymer of methacrylic acid and acrylic acid, especially a copolymer of 50-85 wt % acrylic acid and 15-50 wt % methacrylic acid, based on the total weight of the copolymer.

The aqueous dispersion (B) can be produced by ordinary technologies such as solution polymerization, emulsion polymerization or dispersion polymerization, optionally in the presence of any ordinary additives or processing aids, such as surfactant, initiator, chain transfer agent, coupling agent, crosslinking agent, chain extender, etc.

According to an embodiment of the present disclosure, the aqueous dispersion (B) has a solid content of 25 wt % to 55 wt %, based on the total weight of the aqueous dispersion (B), such as 28-50 wt %, or 30-55 wt %, or 32-50 wt %, or 35-40 wt %, or within a numerical range obtained by combining any two of the following end point values: 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %.

The relative content of the aqueous dispersion (B) can be from 0.05 wt % to 5 wt %, or 0.1-4 wt %, or 0.2-3 wt %, or 0.3-2 wt %, or 0.4-1 wt %, based on the total weight of the aqueous pigment composition, or within a numerical range obtained by combining any two of the following end point values: 0.05 wt %, 0.06 wt %, 0.08 wt %, 0.1 wt %, 0.12 wt %, 0.15 wt %, 0.18 wt %, 0.2 wt %, 0.22 wt %, 0.25 wt %, 0.28 wt %, 0.3 wt %, 0.32 wt %, 0.35 wt %, 0.38 wt %, 0.4 wt %, 0.42 wt %, 0.45 wt %, 0.48 wt %, 0.5 wt %, 0.52 wt %, 0.55 wt %, 0.58 wt %, 0.6 wt %, 0.65 wt %, 0.7 wt %, 0.75 wt %, 0.8 wt %, 0.85 wt %, 0.9 wt %, 0.95 wt %, 1 wt %, 1.5 wt %, 2 wt %, 2.5 wt %, 3 wt %, 3.5 wt %, 4 wt %, 4.5 wt %, 5 wt %.

### Additives

Any ordinary pigments can be selected to impart the aqueous pigment composition of the present disclosure with desired colors. The pigment can be transparent, translucent or opaque, and exemplary pigments include azo pigment, phthalocyanine pigment, anthraquinone pigment, indigo pigment, quinacridone pigment, dioxazine pigment, arylmethane pigments, or combinations thereof. According to an embodiment of the present disclosure, the pigment can be in the form of a dispersion, such as an aqueous dispersion, having a solid content of about 20 wt % to 60 wt %, such as 25 wt % to 55 wt %, or 30-50 wt %, or 35-45 wt %, or 40-45 wt %.

According to another embodiment, the aqueous pigment composition of the present disclosure comprises from 0.5 wt % to 10 wt % of the pigment, based on the total weight of the aqueous pigment composition, such as 1-9 wt %, or 2-8 wt %, or 3-7 wt %, or 4-6 wt %, or 5-5.5 wt %, or within a numerical range obtained by combining any two of the following end point values: 0.5 wt %, 0.6 wt %, 0.7 wt %, 0.8 wt %, 0.9 wt %, 1 wt %, 1.2 wt %, 1.4 wt %, 1.5 wt %, 1.8 wt %, 2 wt %, 2.2 wt %, 2.5 wt %, 2.8 wt %, 3 wt %, 3.2 wt %, 3.5 wt %, 3.8 wt %, 4 wt %, 4.2 wt %, 4.5 wt %, 4.8 wt %, 5 wt %, 5.2 wt %, 5.5 wt %, 5.8 wt %, 6 wt %, 6.2 wt %, 6.5 wt %, 6.8 wt %, 7 wt %, 7.2 wt %, 7.5 wt %, 7.8 wt %, 8 wt %, 8.2 wt %, 8.5 wt %, 8.8 wt %, 9 wt %, 9.2 wt %, 9.5 wt %, 9.8 wt %, 10 wt %.

Thickener includes any compounds ordinarily used for increasing the viscosity and consistence of the aqueous pigment composition of the present disclosure, and exemplary thickener may include polyacrylic thickener, polyurethane thickener, cellulose thickener (e.g. methyl cellulose, carboxymethyl cellulose, hydroxyethyl cellulose, hydroxypropyl methyl cellulose), polyether thickener (e.g. polyethylene oxide, AES), polyester thickener (e.g. PEG-150 distearate), aliphatic acid thickener (e.g. lauric acid, linoleic acid, linolenic acid, myristic acid, stearic acid), aliphatic alcohol thickener (e.g. lauryl alcohol, myristyl alcohol, decyl alcohol, hexyl alcohol, octanol, cetyl alcohol, stearyl alcohol, behenyl alcohol), inorganic salt thickener (e.g. monoethanolamine chloride, diethanolamine chloride, sodium sulfate, sodium phosphate, disodium phosphate, and pentasodium triphosphate), alkanolamide thickener (e.g. coco diethanolamide), amine oxide thickener, natural gum thickener (e.g. starch, acacia, pectin, agar, gelatin, algin, carrageenan, dextrin, gelatin, soluble starch, polysaccharide), and combinations thereof. According to a specific embodiment, the aqueous pigment composition of the present disclosure comprises from 0.1 wt % to 15 wt % of the thickener, based on the total weight of the aqueous pigment composition, such as 0.2-12 wt %, or 0.5-10 wt %, or 0.8-8 wt %, or 1-5 wt %, or 1.5-2 wt %, or within a numerical range obtained by combining any two of the following end point values: 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, 2 wt %, 2.2 wt %, 2.5 wt %, 2.8 wt %, 3 wt %, 3.2 wt %, 3.5 wt %, 3.8 wt %, 4 wt %, 4.2 wt %, 4.5 wt %, 4.8 wt %, 5 wt %, 5.2 wt %, 5.5 wt %, 5.8 wt %, 6 wt %, 6.2 wt %, 6.5 wt %, 6.8 wt %, 7 wt %, 7.5 wt %, 8 wt %, 8.5 wt %, 9 wt %, 9.5 wt %, 10 wt %, 10.5 wt %, 11 wt %, 11.5 wt %, 12 wt %, 12.5 wt %, 13 wt %, 13.5 wt %, 14 wt %, 14.5 wt %, 15 wt %.

The aqueous pigment composition may further contain conventional additives such as fillers, extenders, anti-migration aids, curing agents, coalescents, biocides, plasticizers, organosilanes, anti-foaming agents, corrosion inhibitors, waxes or anti-oxidants.

According to a specific embodiment, the aqueous pigment composition is formaldehyde-free, which means that the composition is substantially free of formaldehyde, nor does it liberate substantial amount of formaldehyde as a result of drying and/or curing. In order to minimize the formaldehyde content of the aqueous pigment composition, the preparation of the aqueous pigment composition of the present invention, especially the polymerization for preparing the aqueous emulsion and the aqueous dispersion, particularly elect formaldehyde-free agents such as, comonomers, initiators, reducing agents, chain transfer agents, surfactants, crosslinking agent and the like, which are themselves free from formaldehyde, do not generate formaldehyde during the polymerization process and do not generate or emit formaldehyde during the manufacture of a coated/printed substrate. According to an embodiment, the raw materials used for preparing the aqueous pigment composition do not intentionally comprise any substances which generate formaldehyde during the manufacture, packaging, transportation, storage, application and long-term weathering. For example, the aqueous pigment composition of the present disclosure is free of N-methylolacrylamide (NMA) and N-methylolmethacrylamide (NMMA), which have been generally known as formaldehyde-emissive crosslinking agent.

The aqueous pigment composition of the present disclosure can be prepared by bending the aqueous emulsion (A), the aqueous dispersion (B), the pigment, the thickener, water and any additional additives (if any) under agitation.

### Applications

A method for producing a coated article using the aqueous pigment composition as well as a coated article prepared by using the same are also disclosed. The aqueous pigment composition of the present disclosure can be used for various applications such as garment, tent, packaging material, container, vessel, building, vehicle, furniture, industrial apparatus, household appliances etc. The aqueous pigment composition can be applied onto one or more surfaces of a substrate by any proper technologies, such as gravure coating, roll coating, knife coating, cast coating, spray coating, dip coating, die coating, blade coating, printing, etc., to form a coating layer, such as a pigment coating layer, partially or completely covering the substrate surface. According to the particular application, the substrate can be made of a material selected from the group consisting of woven fabric, nonwoven fabric, paper, cardboard, wood, wool, cotton, silk, leather, rubber, plastic membrane/film, metal membrane/sheet, glass fiber fabric, carbon fiber fabric, cement, concrete and combinations thereof. The coating layer can be a colored layer covering the whole substrate surface. Alternatively, the coating layer may be applied to some portions (either in continuous or discrete form) of the substrate surface, thus forming image, pattern, letter, character, symbol or random shape.

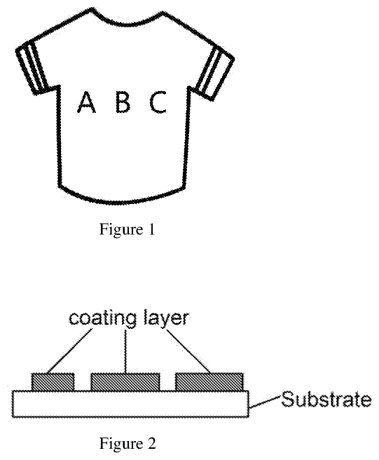

FIG. 1 shows the schematic view of an article, especially a garment, having letters formed by printing the aqueous pigment composition onto selected surface portions, and FIG. 2 shows the sectional view of the garment. The letters formed by the aqueous pigment composition are firmly bonded to the substrate and exhibit no substantial peeling or color change even after long term usage and repeated washing cycles.

### EXAMPLES

Some embodiments of the invention will now be described in the following Examples, wherein all parts and percentages are by weight unless otherwise specified. However, the scope of the present disclosure is not, of course, limited to the formulations set forth in these examples. Rather, the Examples are merely inventive of the disclosure.

The information of the raw materials used in the examples is listed in the following table 1:

TABLE 1
Raw materials used in the examples

| Raw Material | Characterization | Vendor |
|---|---|---|
| BA | Butyl Acrylate | Sinopharm Chemical Reagent |
| Sty | Styrene | Sinopharm Chemical Reagent |
| AA | Acrylic Acid | Sinopharm Chemical Reagent |
| IA | Itaconic Acid | Sinopharm Chemical Reagent |
| PRIMAL ECO-36 | Commercialized aqueous emulsion comprising a copolymer | Dow Chemical Company |
| | of BA/St/AN/AA/NMA, having a solid content of 47.09 wt % | |
| APS | Ammonia Persulfate | Sinopharm Chemical Reagent |
| t-BHP | Tert-Butyl Hydroperoxide | Tokyo Chemical Industry |
| HEMA | Hydroxyethyl Methacrylate | Tokyo Chemical Industry |
| RHODACAL DS-4 | Surfactant, Sodium Dodecylbenzene Sulfonate | Solvay Chemical |
| ACUSOL 465 | Commercialized aqueous dispersion comprising a copolymer | Dow Chemical Company |
| | of AA/Maleic Anhydride(MA), having a solid content of 40 | |
| | wt % | |
| ACUSOL 505N | Commercialized aqueous dispersion comprising a copolymer | Dow Chemical Company |
| | of AA/MA, having a solid content of 35 wt % | |
| COLANYL BLUE A2R 131 | Pigment | Clariant |
| LYOPRINT PT-RV | Thickener | Huntsman |
| DI water | Deionized Water | — |

### Example 1: Preparation of One-Stage Aqueous Emulsion

A one-stage aqueous emulsion was prepared in this example according to the following procedures: a solution containing 8.42 g RHODACAL DS-4 and 467 g DI water were placed in a 5-necked, 5 liter round bottom flask equipped with a thermocouple, a cooling condenser and an agitator, and heated to 84° C. under nitrogen. 20.56 g IA was dissolved in 235 g DI water to form an aqueous solution, which was heated to 60° C. and feed into the flask. 2.43 g RHODACAL DS-4 was dissolved in 362 g deionized water, into which 27.3 g HEMA, 34.2 g AA, 1039 g BA and 109.4 g Sty were slowly added under stirring to form a first monomer emulsion. 78.7 g of the first monomer emulsion was charged into the flask, followed by the addition of a solution of 4.11 g APS in 45 g DI water. The temperature within the flask increased as the reaction proceeded. When a peak temperature of 84° C. was reached, the rest part of the first monomer emulsion and a solution of 1.34 g APS in 68 g DI water were gradually added within 150 minutes, during which the flask was kept at a temperature of 83° C. 15 to 85° C. As the addition has completed, the vessels for containing the first monomer emulsion and the feeding pipes leading into the flask were rinsed with 45 g DI water, and the rinsing water was added back to the flask, after which the flask was held at 84° C. for another 15 minutes. Then 1.5 g of 0.5 wt % aqueous solution of FeSO₄, a solution of 0.87 g t-BHP in 20 g DI water and a solution of 0.57 g IAA in 20 g DI water were added into the flask and the reaction proceeded for 15 minutes, after which a solution of 0.87 g t-BHP in 15 g DI water a solution of 0.57 g IAA 15 g DI water were feed into the flask. Then a solution of 3.62 g t-BHP in 55 g DI water and a solution of 2.3 g IAA in 55 g DI water were slowly added into the flask over 45 minutes. Then the flask was cooled to ambient temperature. Ammonia solution was used to adjust the pH of the resultant emulsion to about 7.0, and the emulsion was further diluted to a solid content of 46 wt %. The emulsion prepared in this Example was a one-stage aqueous emulsion of a BA/St/AA/IA/HEMA copolymer and was referred as Emulsion 1 hereafter.

### Example 2: Preparation of Two-Stage Aqueous Emulsion

A two-stage aqueous emulsion was prepared in this example according to the following procedures: a solution containing 8.42 g RHODACAL DS-4 and 467 g DI water were placed in a 5-necked, 5 liter round bottom flask equipped with a thermocouple, a cooling condenser and an agitator, and heated to 84° C. under nitrogen. 20.56 g IA was dissolved in 235 g DI water to form an aqueous solution, which was heated to 60° C. and feed into the flask. 2.43 g RHODACAL DS-4 was dissolved in 362 g deionized water, into which 27.3 g HEMA, 34.2 g AA, 1039 g BA and 109.4 g Sty were slowly added under stirring to form a first monomer emulsion. 78.7 g of the first monomer emulsion was charged into the flask, followed by the addition of a solution of 4.11 g APS in 45 g DI water. The temperature within the flask increased as the reaction proceeded. When a peak temperature of 84° C. was reached, the rest part of the first monomer emulsion and a solution of 1.34 g APS in 68 g DI water were gradually added within 150 minutes, during which the flask was kept at a temperature of 83° C. to 85° C. As the addition has completed, the vessels for containing the first monomer emulsion and the feeding pipes leading into the flask were rinsed with 45 g DI water, and the rinsing water was added back to the flask, after which the flask was held at 84° C. for another 15 minutes. A second monomer emulsion was prepared before hand by dissolving 1.13 g RHODACAL DS-4 in 110 g deionized water and slowly adding 13.7 g AA and 123 g Sty therein. The second monomer emulsion, 1.5 g of 0.5 wt % aqueous solution of FeSO₄, a solution of 0.87 g t-BHP in 20 g DI water and a solution of 0.57 g IAA in 20 g DI water were added into the flask and the reaction proceeded for 15 minutes, after which a solution of 0.87 g t-BHP in 15 g DI water a solution of 0.57 g IAA 15 g DI water were feed into the flask. Then a solution of 3.62 g t-BHP in 55 g DI water and a solution of 2.3 g IAA in 55 g DI water were slowly added into the flask over 45 minutes. When the polymerization has finished, the flask was cooled to ambient temperature. Ammonia solution was used to adjust the pH of the resultant emulsion to about 7.0, and the emulsion was further diluted to a solid content of 46 wt %. The emulsion prepared in this Example was a two-stage aqueous emulsion of a BA/St/AA/IA/HEMA//St/AA copolymer formulation and was referred as Emulsion 2 hereafter.

### Example 3: Preparation of Two-Stage Aqueous Emulsion without Hydroxyl-Containing Monomer

A two-stage aqueous emulsion was prepared in this example according to the following procedures: a solution containing 8.42 g RHODACAL DS-4 and 467 g DI water were placed in a 5-necked, 5 liter round bottom flask equipped with a thermocouple, a cooling condenser and an agitator, and heated to 84° C. under nitrogen. 20.56 g IA was dissolved in 235 g DI water to form an aqueous solution, which was heated to 60° C. and feed into the flask. 2.43 g RHODACAL DS-4 was dissolved in 362 g deionized water, into which 34.2 g AA, 1039 g BA and 136.7 g Sty were slowly added under stirring to form a first monomer emulsion. 78.7 g of the first monomer emulsion was charged into the flask, followed by the addition of a solution of 4.11 g APS in 45 g DI water. The temperature within the flask increased as the reaction proceeded. When a peak temperature of 84° C. was reached, the rest part of the first monomer emulsion and a solution of 1.34 g APS in 68 g DI water were gradually added within 150 minutes, during which the flask was kept at a temperature of 83° C. to 85° C. As the addition has completed, the vessels for containing the first monomer emulsion and the feeding pipes leading into the flask were rinsed with 45 g DI water, and the rinsing water was added back to the flask, after which the flask was held at 84° C. for another 15 minutes. A second monomer emulsion was prepared before hand by dissolving 1.13 g RHODACAL DS-4 in 110 g deionized water and slowly adding 13.7 g AA and 123 g Sty therein. The second monomer emulsion, 1.5 g of 0.5 wt % aqueous solution of FeSO₄, a solution of 0.87 g t-BHP in 20 g DI water and a solution of 0.57 g IAA in 20 g DI water were added into the flask and the reaction proceeded for 15 minutes, after which a solution of 0.87 g t-BHP in 15 g DI water a solution of 0.57 g IAA 15 g DI water were feed into the flask. Then a solution of 3.62 g t-BHP in 55 g DI water and a solution of 2.3 g IAA in 55 g DI water were slowly added into the flask over 45 minutes. When the polymerization has finished, the flask was cooled to ambient temperature. Ammonia solution was used to adjust the pH of the resultant emulsion to about 7.0, and the emulsion was further diluted to a solid content of 46 wt %. The emulsion prepared in this Example was a two-stage aqueous emulsion of a BA/St/AA/IA//St/AA copolymer formulation and was referred as Emulsion 3 hereafter. This emulsion 3 was free of hydroxyl functionality and was used for comparative example.

### Examples 4-6 and Comparative Examples 1-3

In Examples 4-6 and Comparative Examples 1-3, aqueous pigment compositions (in the form of paste) were prepared by mixing all the components according to the formulations listed in Table 2 for 15 minutes.

TABLE 2
Formulations of Examples 4-6 and Comparative Example (Co. Example) 1-3

| | Example 4 | Example 5 | Example 6 | Co. Example 1 | Co. Example 2 | Co. Example 3 |
|---|---|---|---|---|---|---|
| PRIMAL ECO-36 | — | — | — | 8.92 | — | — |
| Emulsion 1 | 9.11 | — | — | — | — | — |
| Emulsion 2 | — | 9.11 | 9.11 | — | — | 9.11 |
| Emulsion 3 | — | — | — | | 9.23 | — |
| ACUSOL 465 | 0.46 | 0.46 | — | — | — | — |
| ACUSOL 505N | — | — | 0.46 | — | — | — |
| COLANYL BLUE | 5.25 | 5.25 | 5.25 | 5.25 | 5.25 | 5.25 |
| A2R 131 | | | | | | |
| LYOPRINT PT-RV | 1.5 | 1.5 | 1.5 | 1.5 | 1.5 | 1.5 |
| NH₃•H₂O | 0.35 | 0.35 | 0.35 | 0.35 | 0.35 | 0.35 |
| DI water | 83.33 | 83.33 | 83.33 | 83.98 | 83.67 | 83.79 |
| Total | 100 | 100 | 100 | 100 | 100 | 100 |

### Characterization

A piece of 40 cm×40 cm cotton fabric was fastened on the Zimmer Printing Table (Mini MDF R 397 model) and covered with a screen having a screen line of 125 mesh. Each of the pastes prepared in the inventive Examples 4-6 and Comparative Examples 1-3 was printed onto the cotton fabric by screen printing with the processing parameters of bar diameter: 10 mm, pressure: 2, max speed, One cycle: Left-Right-Left. The printed cotton fabric was dried and cured at 150° C. for 3 minutes.

Each of the coated cotton fabrics was characterized by the following technologies.

### Colorfastness to Crocking

The colorfastness to crocking of each coated fabrics was characterized according to AATCC 8-2005, and the Gray Scale for Staining was measured on Colormeter according to AATCC Evaluation Procedure 2 (2005). The characterization results were summarized in Table 3, wherein smaller Gray Scale and larger ΔE* value represent darker and undesirable stain color.

TABLE 3
Colorfastness to Wet Crocking

Wet Crocking

| | Gray Scale-Stain | Δ E* |
|---|---|---|
| Example 4 | 2.5 | 21.23 |
| Example 5 | 2.5 | 20.48 |
| Example 6 | 2.5 | 20.04 |
| Co. Example 1 | 2 | 23.08 |
| Co. Example 2 | 2 | 22.95 |
| Co. Example 3 | 2 | 27.05 |

### Washing Resistance

The washing resistance of each coated fabrics was characterized according to AATCC 61-2003, and the Gray Scale for Color Change was measured on Colormeter according to AATCC Evaluation Procedure 1 (2002).

The washing condition is:
1st cycle: 40° C., water and commercial washing liquid (20 ml), wringer 1000 rpm, 1 hour washing+2 hours drying @66° C.;
2nd cycle: 60° C., water and commercial washing liquid (20 ml), wringer 1000 rpm, 1 hour washing+2 hours drying @66° C.;
3rd cycle: 90° C., water and commercial washing liquid (20 ml), wringer 1000 rpm, 1 hour washing+2 hours drying @66° C.

The characterization results were summarized in Table 4, wherein smaller Gray Scale change and larger ΔE* value represent more significant and undesirable color change.

TABLE 4
Washing Resistance

| | Gray change | ΔE* at | Gray change | ΔE* at | Gray change | ΔE* at |
|---|---|---|---|---|---|---|
| | at 40° C. | 40° C. | at 60° C. | 60° C. | at 90° C. | 90° C. |
| Example 3 | 4.5 | 1.01 | 4 | 1.93 | 3.5 | 3.1 |
| Example 4 | 4.5 | 0.46 | 4.5 | 1.4 | 3.5 | 2.38 |
| Example 5 | 4.5 | 0.94 | 4 | 1.98 | 3.5 | 3.16 |
| Co. Example 1 | 4.5 | 0.86 | 4 | 2.01 | 3 | 3.35 |
| Co. Example 2 | 4.5 | 1.03 | 4 | 2.26 | 3 | 3.7 |
| Co. Example 3 | 4 | 1.46 | 4 | 2.24 | 3 | 3.66 |

As can be learnt from the characterization results listed in Table 3 and Table 4, the pasts of Examples 4 to 6 could achieve significant improvement in both the color fastness against crocking and the washing resistance over those of the comparative examples.

Besides, it was further discovered that the past of Example 5 and 6, which were prepared by using two-stage emulsion, had achieved further improvement over Example 4, which comprised one-stage emulsion.

1. A formaldehyde-free aqueous pigment composition, comprising:
(A) an aqueous emulsion comprising a hydroxyl group functionalized copolymer derived from the polymerization of monomers including, based on the total weight of the copolymer, from 0.2 wt % to 15 wt % of at least one hydroxyl-containing ethylenically unsaturated C₂-C₁₂ carboxylic monomer, from 70 wt % to 95 wt % of at least one ethylenically unsaturated C₂-C₁₂ mono-carboxylic monomer, from 0.2 wt % to 15 wt % of at least of ethylenically unsaturated C₂-C₁₂ di-carboxylic monomer;
(B) an aqueous dispersion comprising a carboxylic acid group functionalized (co)polymer derived from the polymerization of monomer(s) comprising at least one ethylenically unsaturated C₂-C₁₂ carboxylic monomer;
(C) pigment; and
(D) thickener.

2. The formaldehyde-free aqueous pigment composition of claim 1, wherein the aqueous emulsion is a two-stage emulsion of
(i) a first stage component comprising the hydroxyl group functionalized copolymer; and
(ii) a second stage component comprising a (co)polymer derived from the polymerization of monomer(s) including one or more ethylenically unsaturated monomers;
wherein the weight ratio between the first stage component and the second stage component is from 20:1 to 1:1.

3. The formaldehyde-free aqueous pigment composition of claim 2, wherein
the hydroxyl-containing ethylenically unsaturated C₂-C₁₂ carboxylic monomer is selected from the group consisting of hydroxyl(C₁-C₁₂)alkyl (meth)acrylate, hydroxyl(C₁-C₁₂)alkyl crotonate, hydroxyl(C₁-C₁₂)alkyl pentenate, hydroxyl(C₁-C₁₂)alkyl 3,3-dimethyl pentenate, hydroxyl(C₁-C₁₂)alkyl hexenoate, hydroxyl(C₁-C₁₂)alkyl heptenoate, hydroxyl(C₁-C₁₂)alkyl octenoate, hydroxyl(C₁-C₁₂)alkyl nonenoate, hydroxyl(C₁-C₁₂)alkyl decenoate, hydroxyl(C₁-C₁₂)alkyl fumarate, di(hydroxyl(C₁-C₁₂)alkyl) fumarate, (hydroxyl(C₁-C₁₂)alkyl) ((C₁-C₁₂)alkyl) fumarate, hydroxyl(C₁-C₁₂)alkyl maleate, di(hydroxyl(C₁-C₁₂)alkyl) maleate, (hydroxyl(C₁-C₁₂)alkyl)((C₁-C₁₂)alkyl) maleate, hydroxyl(C₁-C₁₂)alkyl 2-methylmaleate, di(hydroxyl(C₁-C₁₂)alkyl)2-methylmaleate, (hydroxyl(C₁-C₁₂)alkyl)((C₁-C₁₂)alkyl) 2-methylmaleate, hydroxyl(C₁-C₁₂)alkyl itaconate, di(hydroxyl(C₁-C₁₂)alkyl) itaconate, (hydroxyl(C₁-C₁₂)alkyl)((C₁-C₁₂)alkyl) itaconate, hydroxyl(C₁-C₁₂)alkyl 2-methyl-itaconate, di(hydroxyl(C₁-C₁₂)alkyl) 2-methyl-itaconate, (hydroxyl(C₁-C₁₂)alkyl)((C₁-C₁₂)alkyl) 2-methyl-itaconate, hydroxyl(C₁-C₁₂)alkyl glutaconate, di(hydroxyl(C₁-C₁₂)alkyl) glutaconate, (hydroxyl(C₁-C₁₂)alkyl)((C₁-C₁₂)alkyl) glutaconate, hydroxyl(C₁-C₁₂)alkyl muconate, di(hydroxyl(C₁-C₁₂)alkyl) muconate, (hydroxyl(C₁-C₁₂)alkyl)((C₁-C₁₂)alkyl) muconate, and combinations thereof;
the ethylenically unsaturated C₂-C₁₂ mono-carboxylic monomer is selected from the group consisting of (meth)acrylic acid, crotonic acid, pentenoic acid, hexenoic acid, heptenic acid, octenoic acid, nonenoic acid, caproleic acid, and salt, anhydride or (C₁-C₁₂)alkyl ester thereof;
the ethylenically unsaturated C₂-C₁₂ di-carboxylic monomer is selected from the group consisting of fumaric acid, maleic acid, 2-methyl maleic acid, itaconic acid, 2-methyl itaconic acid, glutaconic acid, muconic acid, and salt, anhydride or ester thereof;
the ethylenically unsaturated C₂-C₁₂ carboxylic monomer for the aqueous dispersion (B) is selected from the group consisting of (meth)acrylic acid, crotonic acid, pentenoic acid, hexenoic acid, heptenic acid, octenoic acid, nonenoic acid, caproleic acid, fumaric acid, maleic acid, 2-methyl maleic acid, itaconic acid, 2-methyl itaconic acid, glutaconic acid, muconic acid, and salt, anhydride or (C₁-C₁₂)alkyl ester thereof; and
the ethylenically unsaturated monomer for the second stage component is selected from the group consisting of (meth)acrylic acid, crotonic acid, pentenoic acid, hexenoic acid, heptenic acid, octenoic acid, nonenoic acid, caproleic acid, fumaric acid, maleic acid, 2-methyl maleic acid, itaconic acid, and salt, anhydride, (C₁-C₁₂)alkyl ester or hydroxyl(C₁-C₁₂)alkyl ester thereof; hydroxyl-functionalized ethylenically unsaturated C₂-C₁₆ carboxylic acid; styrenic monomer; (meth)acrylamide; diene; vinyl (C₁-C₁₀)carboxylate; (meth)acrylonitrile; and combinations thereof.

4. The formaldehyde-free aqueous pigment composition of claim 2, wherein
the hydroxyl-containing ethylenically unsaturated C₂-C₁₂ carboxylic monomer is selected from the group consisting of hydroxymethyl methacrylate, hydroxymethyl acrylate, hydroxyethyl methacrylate, hydroxyethyl acrylate, hydroxypropyl methacrylate, hydroxypropyl acrylate, hydroxybutyl methacrylate, hydroxybutyl acrylate, hydroxyethyl crotonate, and combinations thereof;
the ethylenically unsaturated C₂-C₁₂ mono-carboxylic monomer is selected from the group consisting of acrylic acid, methacrylic acid, crotonic acid, (C₁-C₆)alkyl acrylate, (C₁-C₆)alkyl methacrylate, (C₁-C₆)alkyl crotonate, and combinations thereof;
the ethylenically unsaturated C₂-C₁₂ di-carboxylic monomer is selected from the group consisting of fumaric acid, maleic acid, itaconic acid, (C₁-C₆)alkyl fumarate, di((C₁-C₆)alkyl) fumarate, (C₁-C₆)alkyl maleate, di((C₁-C₆)alkyl) maleate, (C₁-C₆)alkyl itaconate, di((C₁-C₆)alkyl itaconate) and combinations thereof;
the ethylenically unsaturated C₂-C₁₂ carboxylic monomer for the aqueous dispersion (B) is selected from the group consisting of methacrylic acid, acrylic acid, crotonic acid, fumaric acid, maleic acid, itaconic acid, (C₁-C₆)alkyl methacrylate, (C₁-C₆)alkyl acrylate, (C₁-C₆)alkyl crotonate, (C₁-C₆)alkyl fumarate, di((C₁-C₆)alkyl) fumarate, (C₁-C₆)alkyl maleate, di((C₁-C₆)alkyl) maleate, (C₁-C₆)alkyl itaconate, di((C₁-C₆)alkyl) itaconate, and combinations thereof; and
the ethylenically unsaturated monomer for the second stage component is selected from the group consisting of methacrylic acid, acrylic acid, crotonic acid, fumaric acid, maleic acid, itaconic acid, (C₁-C₆)alkyl methacrylate, hydroxyl(C₁-C₆)alkyl methacrylate, (C₁-C₆)alkyl acrylate, hydroxyl(C₁-C₆)alkyl acrylate, (C₁-C₆)alkyl crotonate, hydroxyl(C₁-C₆)alkyl crotonate, (C₁-C₆)alkyl fumarate, di((C₁-C₆)alkyl) fumarate, hydroxyl(C₁-C₆)alkyl fumarate, di(hydroxyl(C₁-C₆)alkyl) fumarate, (hydroxyl(C₁-C₆)alkyl)((C₁-C₆)alkyl) fumarate, (C₁-C₆)alkyl maleate, hydroxyl(C₁-C₆)alkyl maleate, di((C₁-C₆)alkyl) maleate, di(hydroxyl(C₁-C₆)alkyl) maleate, (hydroxyl(C₁-C₆)alkyl)((C₁-C₆)alkyl) maleate, (C₁-C₆)alkyl itaconate, hydroxyl(C₁-C₆)alkyl itaconate, di((C₁-C₆)alkyl) itaconate, di(hydroxyl(C₁-C₆)alkyl) itaconate, (hydroxyl(C₁-C₆)alkyl)((C₁-C₆)alkyl) itaconate, styrene, (meth)acrylamide, butadiene, isoprene, vinyl acetate, (meth)acrylonitrile, and combinations thereof.

5. The formaldehyde-free aqueous pigment composition of claim 1, wherein the composition has a solid content of from 2 wt % to 20 wt %, based on the total weight of the composition;
the aqueous emulsion (A) has a solid content of 30 wt % to 60 wt %, based on the total weight of the aqueous emulsion;
the aqueous dispersion (B) has a solid content of 25 wt % to 55 wt %, based on the total weight of the aqueous dispersion; and
the composition comprises from 2 wt % to 18 wt % of the aqueous emulsion (A), from 0.05 wt % to 5 wt % of the aqueous dispersion (B), from 0.5 wt % to 10 wt % of the pigment, from 0.1 wt % to 15 wt % of the thickener, and balance amount of water, based on the total weight of the composition.

6. The formaldehyde-free aqueous pigment composition of claim 2, wherein the first stage component further comprises from 1 wt % to 16 wt % of at least one additional comomoner selected from the group consisting of styrenic monomer, (meth)acrylamide, butadiene, isoprene, vinyl acetate, (meth)acrylonitrile, and combinations thereof, based on the total solid weight of the first and second stage components.

7. The formaldehyde-free aqueous pigment composition of claim 1, wherein the composition comprises from 0.5 wt % to 10 wt % of the pigment, based on the total weight of the composition, and
the pigment is selected from the group consisting of azo pigment, phthalocyanine pigment, anthraquinone pigment, indigo pigment, quinacridone pigment, dioxazine pigment, arylmethane pigments, and compositions thereof.

8. The formaldehyde-free aqueous pigment composition of claim 1, wherein the composition comprises from 0.1 wt % to 15 wt % of the thickener, based on the total weight of the composition, and
the thickener is selected from the group consisting of polyacrylic thickener, polyurethane thickener, cellulose thickener, polyether thickener, polyester thickener, aliphatic acid thickener, aliphatic alcohol thickener, inorganic salt thickener, alkanolamide thickener, amine oxide thickener, natural gum thickener, and combinations thereof.

9. A coated article comprising a substrate and a coating layer at least partially covering one or both sides of the substrate, wherein
the coating layer is formed with the formaldehyde-free aqueous pigment composition according to claim 1.

10. The coated article of claim 9, wherein the substrate is selected from the group consisting of woven fabric, nonwoven fabric, paper, cardboard, wood, wool, cotton, rayon, silk, leather, rubber, plastic membrane/sheet, metal membrane/sheet, glass fiber fabric, carbon fiber fabric, cement, concrete and combinations thereof.
